(19) United States
(12) Patent Application Publication
(10) Pub. No.: US 2025/0360715 A1
(43) Pub. Date: Nov. 27, 2025

(54) INKJET RECORDING APPARATUS, HEAD CLEANING METHOD, AND RECORDING MEDIUM

(71) Applicant: Konica Minolta, Inc., Tokyo (JP)

(72) Inventor: Hidehito KISHI, Tokyo (JP)

(21) Appl. No.: 19/210,401

(22) Filed: May 16, 2025

(30) Foreign Application Priority Data
May 21, 2024 (JP) 2024-082483

(51) Int. Cl. B41J 2/165

(52) U.S. Cl. CPC B41J 2/16535; B41J 2002/1655; B41J 2002/16573; B41P 2235/242; B41P 2235/244; B41P 2235/246

(57) ABSTRACT

Disclosed is an inkjet recording apparatus including: a head module including an inkjet head; a wiping cloth for cleaning a head face of the inkjet head; a contact mechanism that causes the wiping cloth to contact and separate from the head face; a wiping cloth conveyor; and a hardware processor. When first and second cleaning operations are performed as two consecutive cleaning operations, an area of the wiping cloth to which ink adheres by the first cleaning operation and an area of the wiping cloth to which ink adheres by the second cleaning operation are first and second ink adhesion areas respectively, in a case where an ink adhesion amount by the first cleaning operation is small, the hardware processor increases an overlapping area of the first and second ink adhesion areas as compared with a case where the ink adhesion amount is large.

### CROSS REFERENCE TO RELATED APPLICATIONS

The present invention claims priority under 35 U.S.C. § 119 to Japanese Application No. 2024-082483, filed on May 21, 2024, the entire contents of which being incorporated herein by reference.

### BACKGROUND OF THE INVENTION

### Technical Field

The present invention relates to an inkjet recording apparatus, a head cleaning method, and a recording medium.

### Description of Related Art

Conventionally, a technique has been known in which a nozzle face of an inkjet head is cleaned using a long sheet member such as a wiping cloth (see, for example, Japanese Unexamined Patent Publication No. 2019-1026).

### SUMMARY OF THE INVENTION

Usually, a portion of the wiping cloth to which ink has adhered once is not used again, and the wiping cloth is gradually consumed every time a cleaning operation is performed. On the other hand, it is required to reduce consumption of the wiping cloth in the cleaning operation for the purpose of reducing a waste amount of the wiping cloth, reducing a replacement frequency of the wiping cloth cartridge, and the like.

The present invention has been made in view of the above-mentioned situations. A problem to be solved by the present invention is to provide an inkjet recording apparatus, a head cleaning method, and a recording medium that can reduce consumption of a wiping cloth.

To achieve at least one of the abovementioned objects, according to an aspect of the present invention, inkjet recording apparatus reflecting one aspect of the present invention is an inkjet recording apparatus comprising:
a head module that is one or a plurality of head modules each including an inkjet head that is one or a plurality of inkjet heads;
a wiping cloth for cleaning a head face of the inkjet head;
a contact mechanism that causes the wiping cloth to contact and separate from the head face;
a wiping cloth conveyor that conveys the wiping cloth; and
a hardware processor that controls the wiping cloth conveyor, wherein
when first and second cleaning operations of two consecutive cleaning operations are defined as a first cleaning operation and a second cleaning operation, respectively, an area of the wiping cloth to which ink adheres by the first cleaning operation is defined as a first ink adhesion area, and an area of the wiping cloth to which ink adheres by the second cleaning operation is defined as a second ink adhesion area,
in a case where an ink adhesion amount to the wiping cloth by the first cleaning operation is small, the hardware processor increases an overlapping area of the first ink adhesion area and the second ink adhesion area as compared with a case where the ink adhesion amount is large.

To achieve at least one of the abovementioned objects, according to another aspect of the present invention, head cleaning method reflecting one aspect of the present invention is a head cleaning method in an inkjet recording apparatus that includes: a head module that is one or a plurality of head modules each including an inkjet head that is one or a plurality of inkjet heads; a wiping cloth for cleaning a head face of the inkjet head; a contact mechanism that causes the wiping cloth to contact and separate from the head face; a wiping cloth conveyor that conveys the wiping cloth; and a hardware processor that controls the wiping cloth conveyor, the method comprising cleaning of the head face with the wiping cloth, wherein
when first and second cleaning operations of two consecutive cleaning operations are defined as a first cleaning operation and a second cleaning operation, respectively, an area of the wiping cloth to which ink adheres by the first cleaning operation is defined as a first ink adhesion area, and an area of the wiping cloth to which ink adheres by the second cleaning operation is defined as a second ink adhesion area, in a case where an ink adhesion amount to the wiping cloth by the first cleaning operation is small, the hardware processor increases an overlapping area of the first ink adhesion area and the second ink adhesion area as compared with a case where the ink adhesion amount is large.

To achieve at least one of the abovementioned objects, according to another aspect of the present invention, recording medium reflecting one aspect of the present invention is a non-transitory computer-readable recording medium storing a program for a computer in an inkjet recording apparatus that includes: a head module that is one or a plurality of head modules each including an inkjet head that is one or a plurality of inkjet heads; a wiping cloth for cleaning a head face of the inkjet head; a contact mechanism that causes the wiping cloth to contact and separate from the head face; a wiping cloth conveyor that conveys the wiping cloth; and the computer, the program causing the computer to function as a hardware processor, wherein
when first and second cleaning operations of two consecutive cleaning operations are defined as a first cleaning operation and a second cleaning operation, respectively, an area of the wiping cloth to which ink adheres by the first cleaning operation is defined as a first ink adhesion area, and an area of the wiping cloth to which ink adheres by the second cleaning operation is defined as a second ink adhesion area,
in a case where an ink adhesion amount to the wiping cloth by the first cleaning operation is small, the hardware processor increases an overlapping area of the first ink adhesion area and the second ink adhesion area as compared with a case where the ink adhesion amount is large.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a schematic configuration diagram of an inkjet recording apparatus according to an embodiment of the present invention;

FIG. 2 is a front view of the image forming section in the inkjet recording apparatus illustrated in FIG. 1;

FIG. 3 is a bottom view of the head unit;

FIG. 4 is a bottom view of the head module;

FIG. 5 is a side view of the head module illustrated in FIG. 4;

FIG. 6 is a perspective view of the head module illustrated in FIG. 4;

FIG. 7 is a diagram illustrating a schematic configuration of a cleaning device;

FIG. 8 is a block diagram illustrating a functional configuration of an embodiment of an inkjet recording apparatus;

FIG. 9 is a flowchart illustrating an example of the flow of inkjet recording;

FIG. 10 is a diagram illustrating a positional relationship between a first ink adhesion area and a second ink adhesion area;

FIG. 11A is a diagram illustrating the positional relationship between the first ink adhesion area A10 and the second ink adhesion area A20;

FIG. 11B is a diagram for illustrating an overlap between the first ink adhesion area and the second ink adhesion area illustrated in FIG. 11A;

FIG. 12A is a diagram illustrating the positional relationship between the first ink adhesion area A10 and the second ink adhesion area A20;

FIG. 12B is a diagram for illustrating an overlap between the first ink adhesion area and the second ink adhesion area illustrated in FIG. 12A;

FIG. 13A is a diagram illustrating the positional relationship between the first ink adhesion area A10 and the second ink adhesion area A20; and

FIG. 13B is a diagram for explaining an overlap between the first ink adhesion area and the second ink adhesion area shown in FIG. 13A.

### DETAILED DESCRIPTION

The following description will describe one or more embodiments of the present invention with reference to the drawings. The effects and features of the embodiment of the present invention will be understood from the following detailed description and the drawings. The following detailed description and drawings are provided for illustration only and do not limit the scope of the present invention.

In the following detailed description and the drawings, directions are expressed using an XYZ orthogonal coordinate system. In the XYZ orthogonal coordinate system, a direction in which a rotary shaft of conveyance drum 21 extends among horizontal directions is defined as a Y direction. Of the horizontal directions, a direction orthogonal to the Y direction is defined as an X direction. The height direction of the inkjet recording apparatus 1 orthogonal to the X direction and the Y direction is defined as a Z direction.

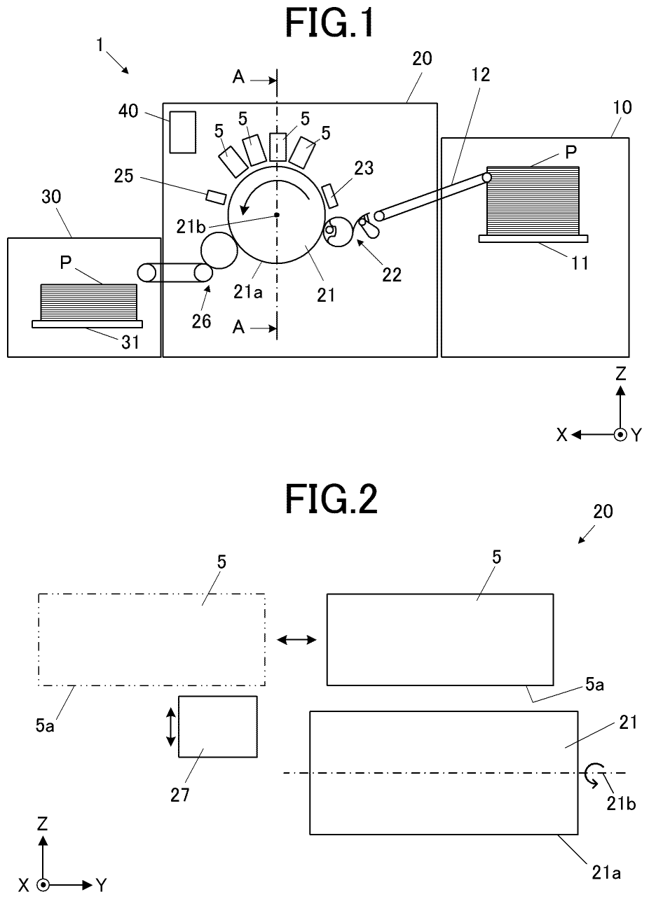

FIG. 1 is a diagram of a schematic configuration of an inkjet recording apparatus 1 according to an embodiment of the present invention. FIG. 2 is a view of the image forming section 20 in the inkjet recording apparatus 1 illustrated in FIG. 1 as viewed from the left side (positive side in the X direction). FIG. 2 schematically shows each component at the position of line A-A in FIG. 1.

As illustrated in FIG. 1, the inkjet recording apparatus 1 may include a medium supply section 10, an image forming section 20, a medium discharge section 30, and a controller 40 (hardware processor). The medium supply section 10 supplies the recording medium P to the image forming section 20. The image forming section 20 forms an image on the recording medium P conveyed from the medium supply section 10. The medium discharge section 30 holds the recording medium P discharged from the image forming section 20. The controller 40 is configured by a computer, and controls the operation of each member configuring the medium supply section 10, the image forming section 20, and the medium discharge section 30.

As the recording medium P, various media capable of fixing the ink landed on the sheet-like principal surface can be used. Examples of the recording medium P include paper, textile, and sheet-like resin. Examples of the paper include plain paper and coated paper.

The medium conveyance section 12 conveys the recording medium P stored on the tray 11 included in the medium supply section 10 to the image forming section 20.

The image forming section 20 includes, as illustrated in FIG. 1 and FIG. 2, for example, a conveyance drum 21, a delivery unit 22, a heating section 23, a head unit 5, a fixing section 25, a delivery section 26, and a cleaning device 27.

The delivery unit 22 is positioned between the medium conveyance section 12 and the conveyance drum 21. The delivery unit 22 holds and picks up one end of the recording medium P conveyed from the media conveyance section 12 and delivers the recording medium P onto the conveyance surface 21a of the conveyance drum 21.

The conveyance drum 21 has a columnar shape, and a side circumferential surface thereof serves as a conveyance surface 21a which adsorbs and holds the recording medium P. Conveyance drum 21 holds recording medium P on its conveyance surface 21a and rotates in one direction (counterclockwise in FIG. 1) with its central axis serving as rotation shaft 21b. Thus, conveyance drum 21 conveys recording medium P attracted to and held by conveyance surface 21a along a path along conveyance surface 21a.

The heating section 23 is positioned on the downstream side of the delivery unit 22 in the rotation direction of the conveyance drum 21. The heating section 23 heats the recording medium P so that the recording medium P conveyed by the conveyance drum 21 has a temperature within a predetermined temperature range. The heating section 23 is formed using, for example, an infrared rays heater or the like. The recording medium P is heated. The heating section 23 is controlled on the basis of the control by the controller 40.

The head unit 5 is positioned on the downstream side of the heating section 23 in the rotation direction of the conveyance drum 21. The head unit 5 forms an image by ejecting ink onto the recording medium P held by the conveyance drum 21 at an appropriate timing corresponding to the rotation of the conveyance drum 21. In the inkjet recording apparatus 1 according to the present embodiment, for example, four head units 5 are arranged at predetermined intervals in order from the upstream side in the rotation direction of the conveyance drum 21. Four head units 5 correspond to inks of four colors, for example, yellow (Y), magenta (M), cyan (C), and black (K), respectively. Each head unit 5 has an ink ejection surface 5a at a position facing the conveyance surface 21a of the conveyance drum 21.

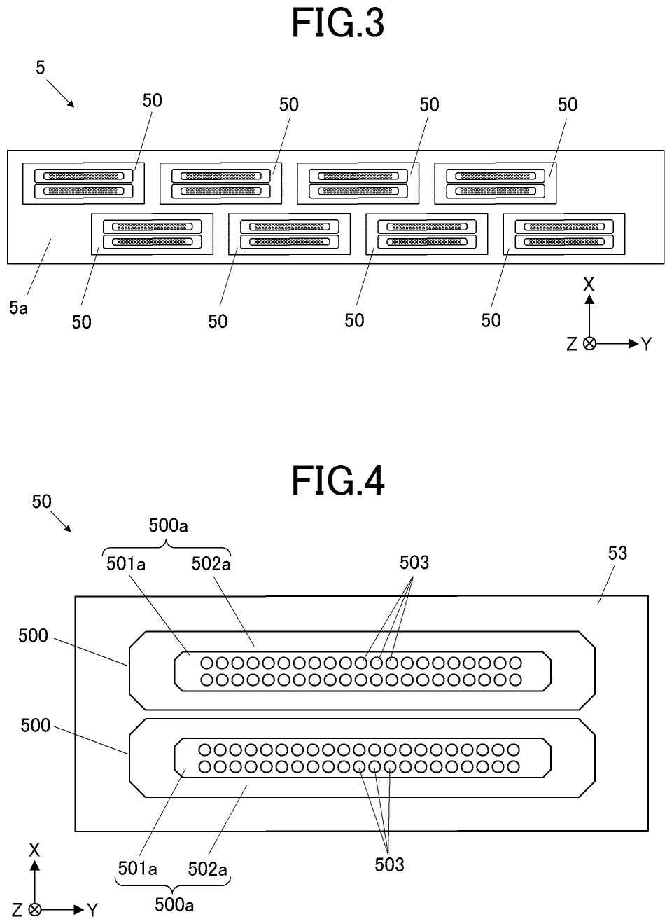

FIG. 3 is a bottom view of the head unit 5 positioned on the line A-A in FIG. 1. As illustrated in FIG. 3, the head unit 5 may include one or more head modules 50. In the example shown in FIG. 3, eight head modules 50 are arranged in a staggered manner on the ink ejection surface 5a of the head unit 5. The other head unit 5 may have the same configuration.

FIG. 4 is a bottom view of the head module 50. As illustrated in FIG. 4, the head module 50 may include one or more inkjet heads 500. In FIG. 4, one head module 50 includes two inkjet heads 500.

As shown in FIG. 4, the head face 500a may include a nozzle face 501a having a plurality of nozzle openings 510 and a top plate 502a positioned to surround the nozzle face 501a.

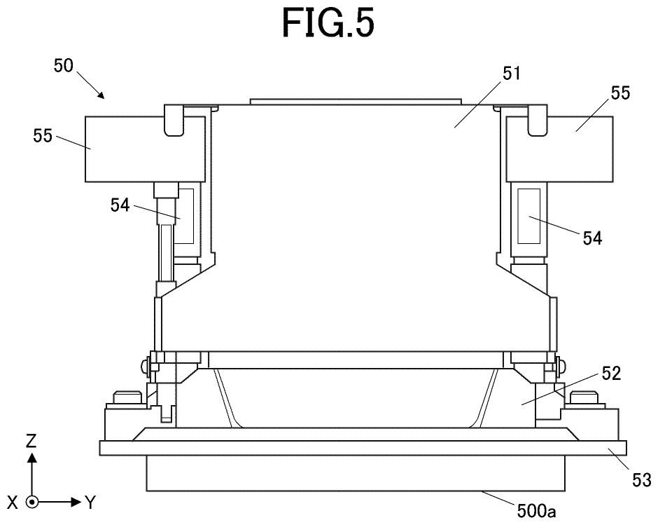

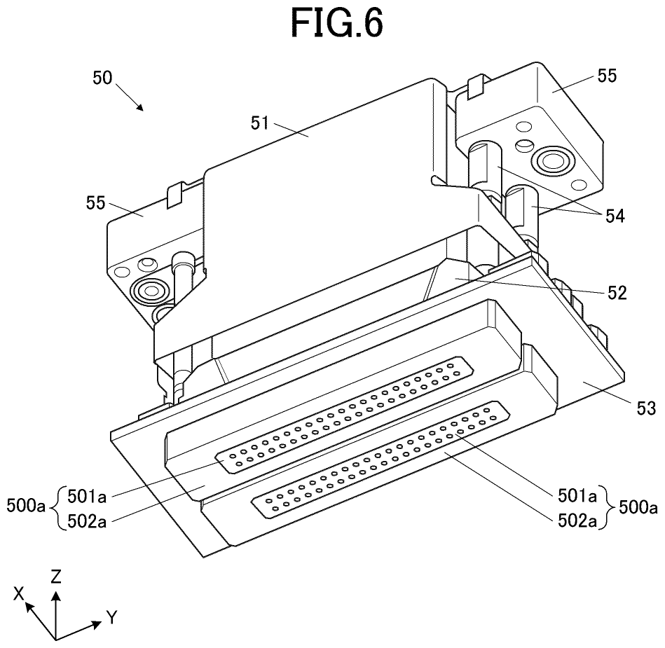

FIG. 5 is a side view of the head module 50 illustrated in FIG. 4. FIG. 6 is a perspective view of the head module 50 illustrated in FIG. 4. As illustrated in FIG. 5 and FIG. 6, the head module 50 may include an exterior material formed of a housing 51, a cover member 52, a fixing member 53, and the like. Inside the exterior material, for example, an ink chamber that stores ink, a pressure chamber, a piezoelectric element, a drive circuit, and the like are housed. The head module 50 may include a connector 54 that communicates with the ink chamber and a tank 55. At this time, the ink is supplied from the tank 55 into the ink chamber via the connector 54.

In the inkjet head 500, when a drive signal is input to the piezoelectric element from the driving circuit substrate based on the control by the controller 40, the piezoelectric element is deformed according to the drive signal, and the pressure chamber is deformed. The inkjet head 500 ejects, from the nozzle openings 510 communicating with the pressure chambers, an amount of ink corresponding to the magnitude of such deformation of the pressure chambers.

It is preferable that the area in which the nozzle openings 510 are disposed in the ink ejection surface 5a of the head unit 5 cover the entire area in the Y direction of the recording medium P which are conveyed by the conveyance drum 21.

The head unit 5 is, for example, each provided in a manner individually movable along the Y direction of the conveyance drum 21. Specifically, the head unit 5 may be provided movably between a position facing the conveyance drum 21 and a position facing the cleaning device 27 provided adjacent to the conveyance drum 21 in the Y direction. When an image is formed, the head unit 5 is moved to a position facing the conveyance drum 21 on the basis of the control by the controller 40, and is used in a state where the position is fixed with respect to the rotation axis 21b of the conveyance drum 21. The inkjet recording apparatus 1 having such a head unit 5 is a single-pass type apparatus.

The head unit 5 moves to a position facing the cleaning device 27 based on the control by the controller 40 at the time of various kinds of maintenance including the cleaning of the ink ejection surface 5a.

The fixing section 25 is provided on the downstream side of the head unit 5 in the rotation direction of the conveyance drum 21. The fixing section 25 includes a light emitting section disposed across the Y direction of the conveyance drum 21. The fixing section 25 like this emits energy beams, such as ultraviolet rays, from the light emitting section onto the recording medium P held on the conveyance surface 21a, to cure and fix the ink ejected onto the recording medium P.

The delivery section 26 is provided at a position between the conveyance drum 21 and the tray 31 of the medium discharge section 30 and on the downstream side of the fixing section 25 in the rotation direction of the conveyance drum 21. The delivery section 26 holds and picks up one end of the recording medium P conveyed on the conveyance surface 21a of the conveyance drum 21, and sends the recording medium Ponto a tray 31 of the medium discharge section 30.

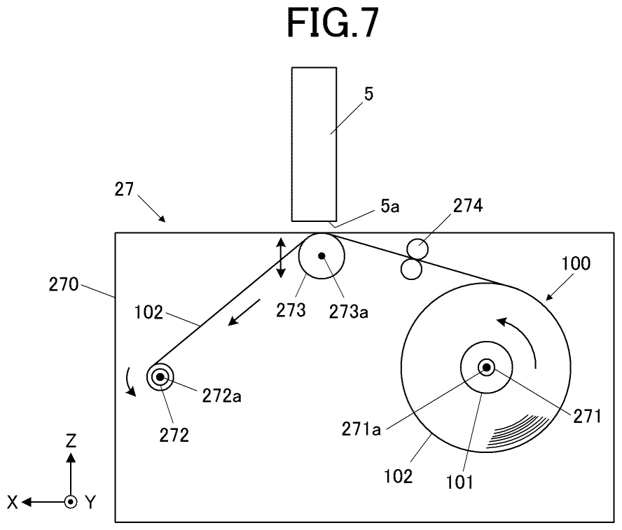

The cleaning device 27 is provided adjacent to the conveyance drum 21 in the Y direction, for example. FIG. 7 is a diagram illustrating a schematic configuration of the cleaning device 27. The cleaning device 27 may include, in the housing 270, a wiping cloth 102, an contact mechanism section 273, a first roller 271 and a second roller 272 that are a wiping cloth conveyor, and a conveyance amount detector 274.

The wiping cloth 102 is unwound from, for example, the wiping cloth cartridge 100. The wiping cloth cartridge 100 is formed by winding a long wiping cloth 102 around a roll core 101. The wiping cloth 102 is a member that cleans the head face 500a of the inkjet head 500. The wiping cloth cartridge 100 is detachably fixed to the first roller 271 by fitting the first roller 271 into the roll core 101, and is freely mounted on the cleaning device 27.

In a state where the wiping cloth cartridge 100 is attached to the cleaning device 27, the outer peripheral edge of the wiping cloth 102 is unwound from the first roller 271, and the unwound outer peripheral edge is fixed to the second roller 272. The wiping cloth 102 is supported by the contact mechanism section 273 between the wiping cloth cartridge 100 fixed to the first roller 271 and the second roller 272.

The wiping cloth 102 is, for example, elongated. The wiping cloth 102 is preferably long enough in the Y direction to cover the length of the head face 500a of the inkjet head 500.

The wiping cloth 102 may be relatively slid with respect to the inkjet head 500 in a state of being in contact with the head face 500a, depending on the cleaning mode. The sliding direction is, for example, the Y direction. At this time, it is preferable that the wiping cloth 102 be longer in the Y direction than a sum of lengths of the head face 500a in the Y direction and the sliding distance. Thus, the wiping cloth 102 can be slid over the entire head face 500a in the sliding direction.

The wiping cloth 102 is preferably made of a raw material that can remove ink and other foreign substances adhering to the head face 500a, and may be, for example, woven fabric or nonwoven fabric. As the woven fabric, a plain weave fabric is preferable from the viewpoint of strength. The material of the wiping cloth 102 may be natural fiber or chemical fiber. As the chemical fiber, nylon (Ny), polyethylene (PE), and a blended fiber or a union fiber using these materials are preferable.

The wiping cloth 102 may be impregnated with a cleaning liquid. As the cleaning liquid, for example, a liquid having a performance of removing ink is used. For example, when a UV curable ink containing a vinyl ether compound, a (meth)acryloyl group-containing compound, and a photoacid generator is used as the ink, a cleaning liquid containing a vinyl ether compound and a (meth)acryloyl group-containing compound is preferably used. It is particularly preferable that the cleaning liquid contain a vinyl ether compound and a (meth)acryloyl group-containing compound that are of the same type or similar type to those of the ink.

The wiping cloth conveyor conveys the wiping cloth 102. The wiping cloth conveyor is composed of, for example, a first roller 271 and a second roller 272. The first roller 271 rotatably holds the wiping cloth cartridge 100. The rotation axis 271a of the first roller 271 extends in, for example, the Y direction. The first roller 271 may be a drive roller that is provided with a motor serving as a drive source and freely rotates in one direction, or may be a driven roller that rotates following the rotation of the second roller 272.

In a case where the first roller 271 includes a motor serving as a drive source, for example, a pulse motor can be used as the motor. Such a motor serving as a drive source operates under the control of the controller 40, and functions as a feed motor for feeding the wiping cloth 102 toward the second roller 272.

The second roller 272 rolls up the wiping cloth 102 from the wiping cloth cartridge 100. The rotation axis 272a of the second roller 272 extends, for example, in the Y direction and is provided parallel to the rotation axis 271a of the first roller 271.

The second roller 272 may have, in its side circumferential wall, a groove-shaped fixing section for fitting and fixing the leading end edge of the wiping cloth 102. The second roller 272 may have a double structure covered with a roll core, and a groove-shaped fixing section for fitting and fixing the leading end edge of the wiping cloth 102 may be provided in the roll core.

The second roller 272 is, for example, a drive roller that includes a motor serving as a drive source and freely rotates in one direction. As the motor provided in the second roller 272, for example, a pulse motor can be used. Such a motor serving as a drive source operates under the operation of the controller 40 and functions as a winding motor for winding up the wiping cloth 102.

The contact mechanism section 273 causes the wiping cloth 102 to come into contact with and separate from the head face 500a. The contact mechanism section 273 is configured as a driven roller in which, for example, a cylindrical side peripheral wall is configured by an elastic body, and the side peripheral wall can freely come into contact with the head face 500a via the wiping cloth 102. The material forming the side peripheral wall of the contact mechanism section 273 is not particularly limited, but is preferably an elastic material such as sponge or rubber. Thus, the nozzle openings 510 are less likely to be damaged during cleaning.

The rotation axis 273a of the contact mechanism section 273 extends, for example, in the Y direction and is provided in parallel with the rotation axis 271a of the first roller 271 and the rotation axis 272a of the second roller 272. The contact mechanism section 273 preferably supports, at its side peripheral walls, an intermediate portion of the wiping cloth 102 stretched between the first roller 271 and the second roller 272.

It is preferable that the length of the contact mechanism section 273 in the Y direction be larger than the length of the wiping cloth 102 in the Y direction (width direction) so that the wiping cloth 102 can be supported in the entire Y direction (width direction).

The contact mechanism section 273 may be provided with a drive source such as a solenoid for freely contact of the side peripheral wall for the head face 500a. Such a drive source operates on the basis of control by the controller 40, and functions as a drive source for bringing the wiping cloth 102, which is wrapped around the side peripheral wall of the contact mechanism section 273, into contact with the head face 500a.

The contact mechanism section 273 may be configured to be movable in the Y direction with respect to the head face 500a. Such an contact mechanism section 273 reciprocates in the Y direction in a state where the wiping cloth 102 is in contact with the head face 500a, thereby enabling a sliding operation of the wiping cloth 102 relative to the head face 500a.

The inkjet recording apparatus 1 preferably includes, in the cleaning device 27, a conveyance amount detector 274 that detects a conveyance amount of the wiping cloth 102. The conveyance amount detector 274 may be positioned on the upstream or the downstream of the contact mechanism section 273 in the conveyance direction of the wiping cloth 102. The conveyance amount detector 274 includes, for example, a roller that rotates with the conveyance of the wiping cloth 102 and an encoder that detects the amount of mechanical displacement of the rotation of the roller to detect the amount of conveyance of the wiping cloth 102. Since the cleaning device 27 includes the conveyance amount detector 274, accuracy of conveyance control of the wiping cloth 102 can be increased.

The cleaning device 27 may include a roller around which the wiping cloth 102 is stretched between the first roller 271 and the second roller 272. The cleaning device 27 may include an imaging apparatus such as a camera capable of capturing an image of an area of the wiping cloth to which the ink is attached.

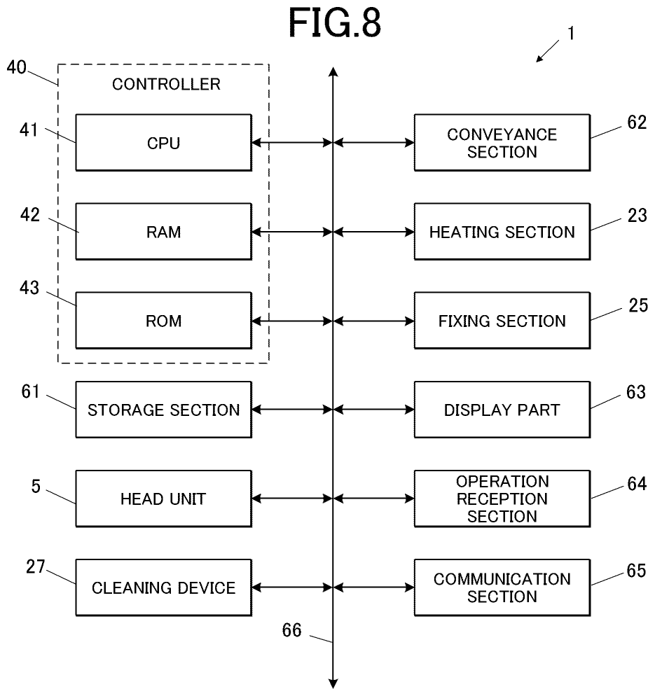

FIG. 8 is a block diagram illustrating the functional configuration of an embodiment of the inkjet recording apparatus 1. The inkjet recording apparatus 1 illustrated in FIG. 8 includes, as a functional configuration, a controller 40, a storage section 61, the head unit 5, the cleaning device 27, a conveyance section 62, the heating section 23, the fixing section 25, a display part 63, an operation reception section 64, a communication section 65, and a bus 66.

The controller 40 controls the operations of the medium supply section 10, the image forming section 20, and the medium discharge section 30 according to the print image data and the print setting. In addition, the controller 40 controls the wiping cloth conveyor of the cleaning device 27 included in the image forming section 20 according to the cleaning setting. The controller 40 is a computer and includes, for example, a central processing unit (CPU) 41, a random access memory (RAM) 42, and a read only memory (ROM) 43. The CPU41 executes various control programs to drive and control the inkjet recording apparatus 1 and perform various arithmetic processing. The RAM42 provides a working memory space for the CPU41 and stores temporary data. The storage device RAM42 may include a nonvolatile memory. The ROM 43 stores various control programs to be executed by the CPU 41, setting data, and the like. A rewritable nonvolatile memory such as a flash memory may be used instead of the nonvolatile memory ROM43.

The storage section 61 stores programs to be executed by the CPU41, various setting information, and the like. As the storage section 61, for example, a hard disk drive (HDD) is used, and a dynamic random access memory (DRAM) or the like is used in combination.

The conveyance section 62 is a motor that drives each section operating to move the recording medium P. The conveyance section 62 operates each section that operates to move the recording medium P at an appropriate timing based on the control by the controller 40.

The display part 63 displays various statuses, menus, and the like on a display screen under the control of the controller 40. The display part 63 includes, for example, a display screen, an LED lamp, and the like. The display screen is not particularly limited, but is, for example, a liquid crystal display (LCD). In the LED lamp, for example, a lamp at a position and in a color corresponding to each situation is turned on according to the power supply situation, the abnormality occurrence situation, and the like.

The operation reception section 64 accepts an external input operation by a user or the like and outputs it as an input signal to the controller 40. The operation reception section 64 includes, for example, a touch screen, a push button switch, and the like. The touch screen may be overlaid on a display screen of the display part 63. The operation reception section 64 may include other various operation switches and the like.

The communication section 65 controls transmission and reception of data (signal) to and from an external device or the like in accordance with a predetermined communication standard. The communication section 65 controls communication in accordance with, for example, a local area network (LAN) standard.

The communication section 65 may be connectable to a peripheral device in accordance with a standard such as USB (Universal Serial Bus).

The bus 66 is a channel for communication of signals between the controller 40 and other functional configurations. Each function component may operate based on a control signal transmitted from a processor (such as a CPU) separate from the controller 40.

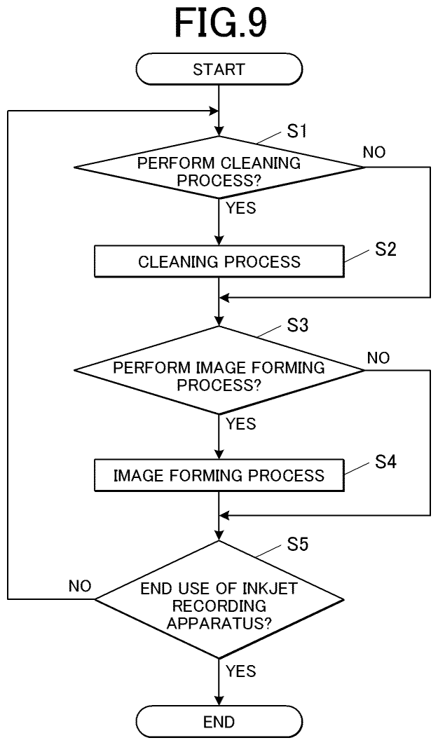

FIG. 9 is a flowchart illustrating an example of the flow of inkjet recording in the inkjet recording apparatus 1 of the present invention.

### Step S1

In step S1, whether or not the cleaning device 27 performs a cleaning process of the head face 500a with the wiping cloth 102 is determined by an instruction from the user, a predetermined setting, or the like. For example, even before the image forming process, the cleaning process may be performed as a part of the initial maintenance immediately after the inkjet recording apparatus 1 is started.

### Step S2

When it is determined in step S1 that “the cleaning process is performed”, the flow proceeds to step S2. In step S2, the cleaning device 27 performs a cleaning process. In the cleaning process, one or a plurality of times of cleaning operation is performed. In one cleaning operation, for example, one or a plurality of head faces 500a included in one head module 50 are cleaned. Assuming that cleaning of one head module 50 is one cleaning operation as described above, in a case where four head units 5 each include eight head modules 50, for example, 32 cleaning operations are performed in succession in one cleaning process.

When the cleaning process is started, one of the head units 5 moves based on the control by the controller 40 so that the position of the ink ejection surface 5a of the head unit 5 becomes a position facing the cleaning device 27. To be specific, the head unit 5 moves so that the position of the head face 500a of one or a plurality of inkjet heads 500 included in the head module 50 becomes a position facing the contact mechanism section 273 of the cleaning device 27.

Subsequently, the cleaning operation is performed on the basis of the control by the controller 40. In the cleaning operation, purging is performed as necessary, and then wiping is performed. The purge is an operation of forcibly ejecting a large amount of ink from the nozzle opening 510 by pressurizing the ink chamber. Thus, ink clogging is prevented or eliminated. In the wiping, the contact mechanism section 273 moves in a direction toward the head face 500a (positive side in the Z direction) on the basis of the control by the controller 40, whereby the wiping cloth 102 is brought into contact with the head face 500a. Next, as necessary, the wiping cloth 102 in contact with the head face 500a is slid. Thereafter, the contact mechanism section 273 moves in a direction away from the head face 500a (the negative side in the Z direction), and the wiping cloth 102 is separated from the head face 500a. By such wiping, residual ink, dust, and the like adhering to the head face 500a are moved to the wiping cloth 102. Through the above-described cleaning operation, the head module 50, specifically, the head faces 500a of the inkjet heads 500 included in the head module 50 are cleaned.

When the cleaning operation for one head module 50 is completed, the head unit 5 moves so that the contact mechanism section 273 faces the head face 500a of the inkjet head 500 of the next head module 50 to be cleaned. Under the control of the controller 40 which will be described later, the second roller 272 of the wiping cloth conveyor rotates in a direction in which the wiping cloth 102 is rewound, and the wiping cloth 102 is conveyed. Thereafter, the same cleaning operation as described above is performed.

When the cleaning operation for all the head modules 50 included in one head unit 5 is completed, the next head unit 5 moves to a position facing the cleaning device 27. This is repeated, and the cleaning operation is performed on all of the head modules 50 included in the inkjet recording apparatus 1. When the cleaning operation for all the head modules 50 is completed, one cleaning process is completed. Note that this is an example of the cleaning process and the cleaning operation does not necessarily have to be performed on all of the head modules 50 in one cleaning process.

### Step S3

After the cleaning process of step S2, alternatively, when it is not determined to “perform the cleaning process” in step S1, the flow proceeds to step S3 after step S1. In step S3, whether or not the image forming section 20 performs an image forming process is determined by an instruction from a user, a predetermined setting, or the like. For example, in a case where the cleaning process of step S2 is performed after the previous image forming process, the image forming process may not be performed even after the cleaning process.

### Step S4

When it is determined in step S3 that “the image forming process is performed”, the flow proceeds to step S4. At step S4, the above-described image forming section 20 performs an image forming process. The number of images formed in the image forming process of step S4 is not particularly limited. Images may be successively formed on a plurality of recording medium P in a single image forming process.

### Step S5

After the image forming process of step S4, alternatively, when it is not determined to “perform the cleaning process” in step S3, the flow proceeds to step S5 after step S3. In step S5, whether or not a user ends use of the inkjet recording apparatus is determined by an instruction by the user, a predetermined setting, or the like.

If it is determined in step S5 that “the use of the inkjet recording apparatus is to be ended”, the inkjet recording ends. When it is not determined in step S5 that “the use of the inkjet recording apparatus is to be ended”, the flow returns to step S1.

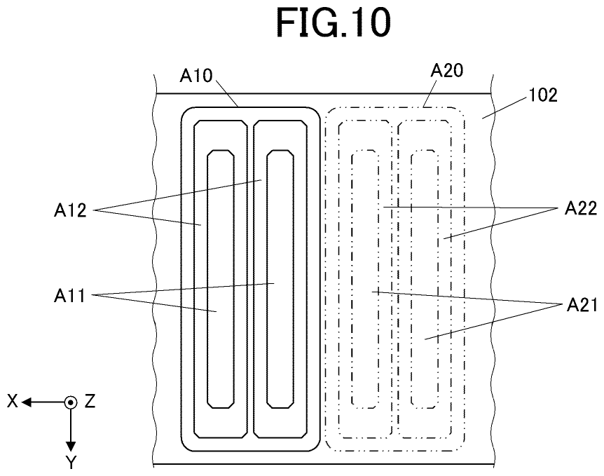

Next, details of the control of the wiping cloth conveyor by the controller 40 will be described. Of the two consecutive cleaning operations performed by the inkjet recording apparatus 1 of the present invention, the first and second cleaning operations are referred to as the first cleaning operation and the second cleaning operation, respectively. As illustrated in FIG. 10 and the like, an area of the wiping cloth 102 to which ink adheres by the first cleaning operation is referred to as a first ink adhesion area A10. An area of the wiping cloth 102 to which ink adheres through the second cleaning operation is defined as a second ink adhesion area A20. At this time, the controller 40 controls the wiping cloth conveyor such that the extent of overlapping areas of the first ink adhesion areas A10 and the second ink adhesion areas A20 are larger in a case where the amount of ink adhesion to the wiping cloth 102 by the first cleaning operation is small than in a case where the amount of ink adhesion is large. Hereinafter, the extent of overlapping area of the first ink adhesion area A10 and the second ink adhesion area A20 is also simply referred to as an “overlapping area”.

In the conventional art, although an area of the wiping cloth 102 to which ink has once adhered has a small amount of ink adhesion and can still be used for cleaning, it is not usually used again. On the contrary, in the present invention, when the ink adhesion amount by the first cleaning operation is small, the wiping cloth conveyor is controlled so that the overlapping area between the first ink adhesion area A10 and the second ink adhesion area A20 becomes large. Therefore, an area (the first ink adhesion area A10) of the wiping cloth 102 to which ink has adhered once may be used again, thus reducing consumption of the wiping cloth 102. At this time, the overlapping area between the first ink adhesion area A10 and the second ink adhesion area A20 can be controlled to be small when the amount of ink adhesion by the first cleaning operation is large, thus facilitating appropriate cleaning of the head face 500a in the second cleaning operation. That is, the present invention reduces consumption of the wiping cloth 102 while appropriately cleaning the head face 500a by controlling the overlapping area between the first ink adhesion areas A10 and the second ink adhesion areas A20 in accordance with the amount of ink adhesion achieved by the first cleaning operation. Thus, the present invention can enable efficient use of the wiping cloth 102.

The first cleaning operation and the second cleaning operation may include another step such as an image forming process therebetween, or may not include another step such as an image forming process therebetween. That is, the first cleaning operation and the second cleaning operation are not limited to being consecutive in the same cleaning process. The last cleaning operation in a certain cleaning process may be the first cleaning operation, and the first cleaning operation in the next cleaning process with another step such as the image forming process interposed therebetween may be the second cleaning operation. However, since the first cleaning operation and the second cleaning operation are two consecutive cleaning operations, no other cleaning operation is interposed therebetween. The head module 50 cleaned in the first cleaning operation and the head module 50 cleaned in the second cleaning operation may be different from or the same as each other.

The “area of the wiping cloth to which ink adheres” is an area of the wiping cloth 102 to which ink adheres by wiping. The “area of the wiping cloth to which the ink adheres” may be larger than the area in contact with the head face 500a, or may be smaller than the area in contact with the head face 500a. For example, in a case where ink is adhered to an entire surface of the head face 500a before wiping, ink moved to the wiping cloth 102 by wiping may bleed and spread, and therefore, “an area in the wiping cloth to which ink is adhered” is likely to be larger than an area in contact with the head face 500a. For example, when the ink does not adhere to the entire area of the head face 500a before the wiping, or when the amount of the ink adhering to the head face 500a is small, the “area of the wiping cloth to which the ink adheres” may be smaller than the area in contact with the head face 500a.

The range of the first ink adhesion area A10 can be the estimated range. The range of the first ink adhesion area A10 can be estimated, for example, based on parameters such as the components of the ink, the degree of drying of the ink, the degree of thickening of the ink, the material of the wiping cloth 102, the thickness of the wiping cloth 102, and the cleaning mode of the first cleaning operation. This estimation can be performed with reference to, for example, a table in which each parameter is associated with the range of the first ink adhesion area A10. The range of the first ink adhesion area A10 may be a range obtained from an image of the wiping cloth 102 acquired by an imaging apparatus such as a camera.

The range of the second ink adhesion area A20 can be the estimated range. The range of the second ink adhesion area A20 can be estimated based on parameters such as the components of the ink, the degree of drying of the ink, the degree of thickening of the ink, the material of the wiping cloth 102, the thickness of the wiping cloth 102, and the cleaning mode of the second cleaning operation. This estimation can be performed with reference to, for example, a table in which each parameter is associated with the range of the second ink adhesion area A20.

The ink adhesion amount to the wiping cloth 102 by the first cleaning operation may be an estimated value. The ink adhesion amount can be estimated on the basis of parameters such as the components of the ink, the degree of drying of the ink, the degree of thickening of the ink, the material of the wiping cloth 102, the thickness of the wiping cloth 102, and the cleaning mode of the first cleaning operation. This estimation can be performed with reference to, for example, a table in which each parameter is associated with an ink adhesion amount. It is preferable that the ink adhesion amount to the wiping cloth 102 by the first cleaning operation is a value estimated on the basis of the cleaning mode of the first cleaning operation.

The cleaning mode is divided into several modes according to the presence or absence of purging in the cleaning operation, the time for which the wiping cloth 102 is made to contact the head face 500a, the presence or absence of sliding of the wiping cloth 102, the sliding range of the wiping cloth 102, the number of times of sliding of the wiping cloth 102, and the like. When it is desired to carefully clean the head face 500a immediately after the inkjet recording apparatus 1 is activated, the cleaning mode can be set to, for example, purging, sliding of the wiping cloth 102, and a relatively large number of times of sliding.

The controller 40 may control the overlapping area in accordance with not only the ink adhesion amount to the wiping cloth 102 by the first cleaning operation but also other parameters in addition to the ink adhesion.

For example, the controller 40 may control the overlapping area also in accordance with the length of a “first elapsed time” defined as follows. The “first elapsed time” refers to an elapsed time from the completion of wiping in the first cleaning operation to the start of wiping in the second cleaning operation. At this time, the controller 40 preferably makes the overlapping area smaller in a case where the first elapsed time is long than in a case where the first elapsed time is short. Further, when the first elapsed time is one hour or more, the controller 40 preferably sets the overlapping area to zero. If the first elapsed time is long, drying and/or thickening of the ink in the first ink adhesion area A10 is likely to proceed, and the amount of dust adhered to the first ink adhesion area A10 is likely to increase. Therefore, if the first elapsed time is long, the cleaning force for the first ink adhesion area A10 tends to decrease. Therefore, by reducing the overlapping area when the first elapsed time is long or by setting the overlapping area to zero when the first elapsed time is one hour or more, the head face 500a is more likely to be appropriately cleaned in the second cleaning operation.

As another example of control, the controller 40 may control the overlapping area also in accordance with the magnitude of a “first denaturation degree” defined as follows. The “first denaturation degree” refers to the degree of drying or thickening, during the second cleaning operation, of the ink adhered to the wiping cloth 102 by the first cleaning operation. At this time, the controller 40 preferably makes the overlapping area smaller when the first denaturation degree is large than when the first denaturation degree is small. If the first denaturation degree is great, the cleaning force for the first ink adhesion area A10 is likely to decrease. Therefore, since the overlapping area is decreased when the first denaturation degree is large, the head face 500a is more likely to be appropriately cleaned in the second cleaning operation.

As another example of control, the controller 40 may control the overlapping area also in accordance with the length of a “second elapsed time” defined as follows. The “second elapsed time” refers to an elapsed time from the completion of wiping in the previous cleaning operation of the second cleaning operation for the second head module defined as follows to the start of wiping in the second cleaning operation. The “second head module” refers to the head module 50 cleaned in the second cleaning operation. At this time, the controller 40 preferably makes the overlapping area smaller in a case where the second elapsed time is long than in a case where the second elapsed time is short. Furthermore, when the second elapsed time is one hour or more, the controller 40 preferably sets the overlapping area to zero. When the second elapsed time is long, drying and/or thickening of the residual ink on the head face 500a of the second head module tends to progress, and the amount of dust adhering to the head face 500a of the second head module tends to increase. Therefore, if the second elapsed time is long, the head face 500a of the second head module is hardly cleaned. In order to appropriately clean the head face 500a of the second head module in such a state, it is preferable to use a large area of the wiping cloth 102 to which ink is not attached. Therefore, the head face 500a of the second head module is more likely to be appropriately cleaned in the second cleaning operation by reducing the overlapping area when the second elapsed time is long or reducing the overlapping area to zero when the second elapsed time is one hour or longer.

As another example of control, the controller 40 may control the overlapping area also in accordance with the magnitude of a “second denaturation degree” defined as follows. The “second denaturation degree” refers to the degree of drying or thickening of the ink adhered to the second head module during the second cleaning operation. At this time, the controller 40 preferably makes the overlapping area smaller when the second denaturation degree is large than when the second denaturation degree is small. If the second denaturation degree is large, the head face 500a of the second head module is hardly cleaned. In order to appropriately clean the head face 500a of the second head module in such a state, it is preferable to use a large area of the wiping cloth 102 to which ink is not attached. Therefore, by reducing the overlapping area when the second denaturation degree is large, the head face 500a of the second head module is likely to be appropriately cleaned in the second cleaning operation.

The controller 40 may control the overlapping area in accordance with a plurality of parameters consisting of any combination of the first elapsed time, the first denaturation degree, the second elapsed time, the second denaturation degree, and the like, in addition to the ink adhesion amount to the wiping cloth 102 by the first cleaning operation.

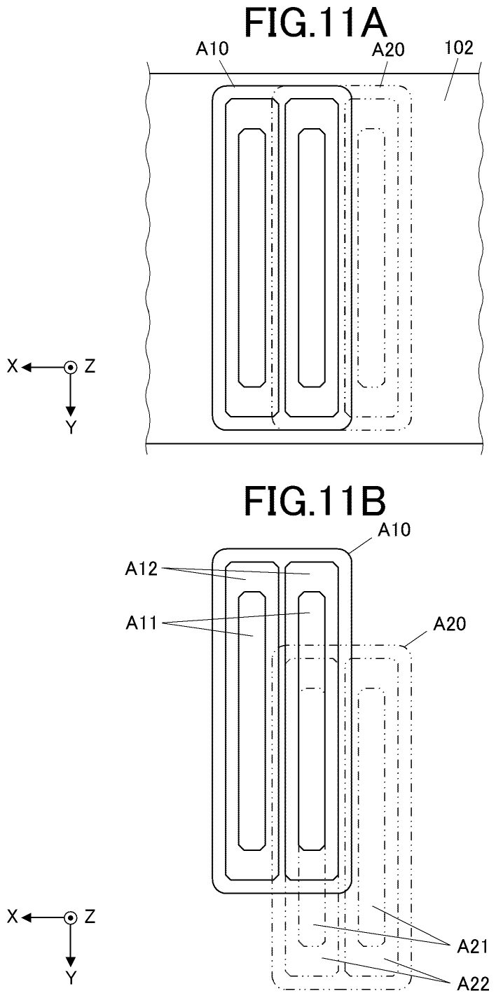

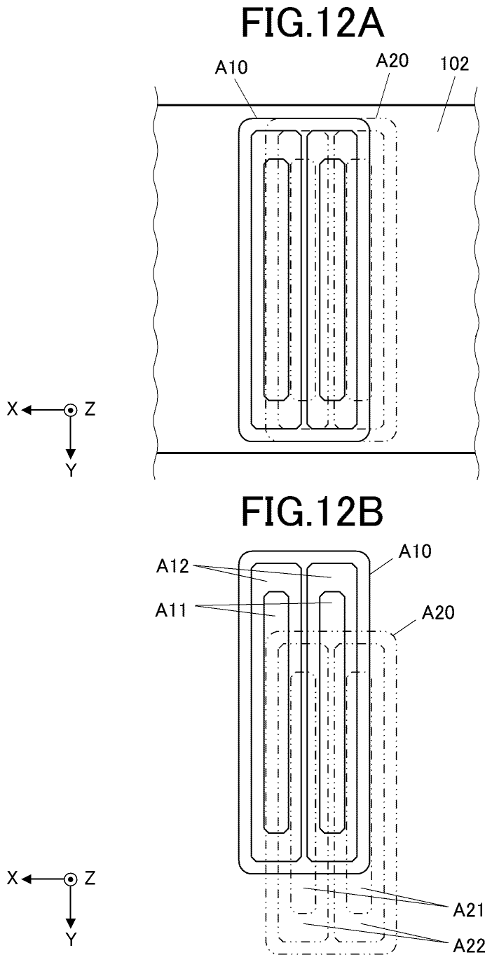

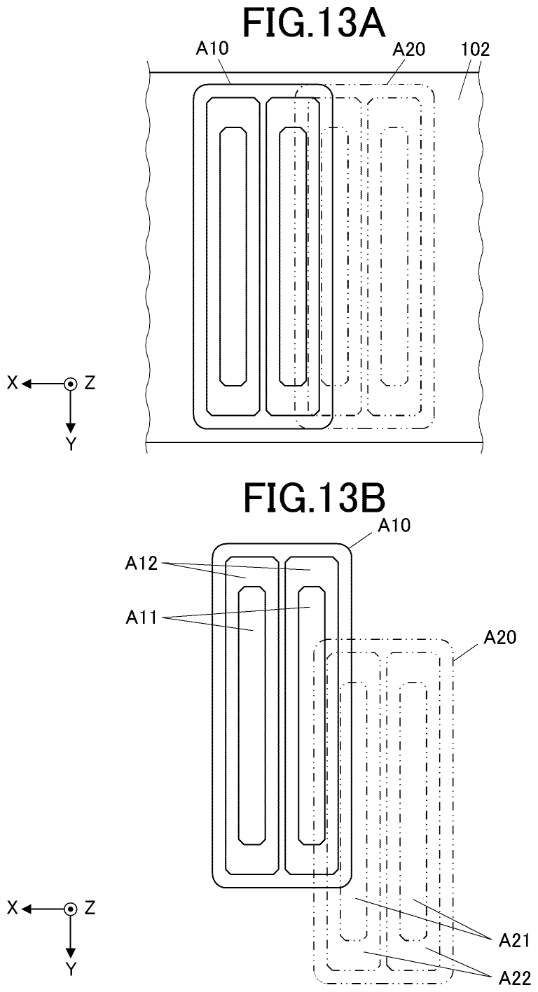

FIG. 10 and FIGS. 11A, FIG. 12A, and FIG. 13A illustrate the positional relationship between the first ink adhesion area A10 and the second ink adhesion area A20 in the wiping cloth 102. FIGS. 11B, FIG. 12B, and FIG. 13B are diagrams for explaining the overlap between the first ink adhesion area A10 and the second ink adhesion area A20 illustrated in FIGS. 11A, FIG. 12A, and FIG. 13A, respectively, and are illustrated with the positional relationship in the Y direction being shifted for convenience.

In these drawings, a first nozzle face contact area A11 is an area of the wiping cloth 102 with which the nozzle face 501a comes into contact during the first cleaning operation. The first top plate contact area A12 is a area of the wiping cloth 102 with which the top plate 502a comes into contact during the first cleaning operation. The second nozzle face contact area A21 is an area of the wiping cloth 102 with which the nozzle face 501a comes into contact during the second cleaning operation. The second top plate contact area A22 is a area of the wiping cloth 102 with which the top plate 502a comes into contact during the second cleaning operation.

For example, the controller 40 may control the wiping cloth conveyor so that the overlapping area becomes 0 as shown in FIG. 10 in the following cases.
Case where the ink adhesion amount to the wiping cloth 102 through the first cleaning operation is equal to or more than an arbitrary set value.
If the first elapsed time and/or the second elapsed time is equal to or longer than an arbitrary set value (e.g., one hour)
If the first denaturation degree and/or the second denaturation degree are/is equal to or more than any set value

Any of the above-described cases is, for example, a case where it is difficult for the entire first ink adhesion area A10 to absorb ink. In such a case, appropriate cleaning of the head faces 500a in the second cleaning operation can be achieved by controlling the wiping cloth conveyor such that the overlapping area becomes zero.

As illustrated in FIG. 11A and FIG. 11B, the controller 40 may control the wiping cloth conveyor such that one of the two first nozzle face contact areas A11 overlaps one of the two second nozzle face contact areas A21. It is preferable that one of the two nozzle faces 501a comes into contact with the second nozzle face contact area A21 that does not overlap the first nozzle face contact area A11 in the next cleaning operation. By repeating this, although the overlapping areas are large to some extent, the number of times that the nozzle face 501a contacts any area of the wiping cloth 102 is two at most. Thus, appropriate cleaning of the head face 500a in the second cleaning operation and a reduction in consumption of the wiping cloth 102 can be achieved at high levels.

As illustrated in FIG. 12A and FIG. 12B, the controller 40 may control the wiping cloth conveyor such that the first nozzle face contact area A11 and the second nozzle face contact area A21 do not overlap each other. At this time, the first top plate contact area A12 and the second nozzle face contact area A21 may overlap each other. Ink adhering to the top plate 502a is mainly derived from scattered mist, and the amount of ink adhering to the top plate 502a is often smaller than that adhering to the nozzle face 501a having the nozzle openings 510. In such a case, the first top plate contact area A12 still has a cleaning force remaining, and can appropriately clean the nozzle face 501a even when being brought into contact with the nozzle face 501a again. Therefore, in such a case, it is preferable to control the wiping cloth conveyor such that the first top plate contact area A12 and the second nozzle face contact area A21 do not overlap each other while the first nozzle face contact area A11 and the second nozzle face contact area A21 overlap each other. Thus, appropriate cleaning of the head face 500a in the second cleaning operation and a reduction in consumption of the wiping cloth 102 can be achieved at high levels.

As illustrated in FIG. 13A and FIG. 13B, the controller 40 may control the wiping cloth conveyor such that the first top plate contact area A12 and the second nozzle face contact area A21 do not overlap each other. At this time, the first top plate contact area A12 and the second top plate contact area A22 may overlap each other. Even when the first top plate contact area A12 can clean the top plate 502a again, the ink may adhere to the top plate 502a to such an extent that the nozzle face 501a cannot be appropriately cleaned again. In such a case, it is preferable to control the wiping cloth conveyor such that the first top plate contact area A12 and the second top plate contact area A22 overlap each other but the first top plate contact area A12 and the second nozzle face contact area A21 do not overlap each other. Thus, appropriate cleaning of the head face 500a in the second cleaning operation and a reduction in consumption of the wiping cloth 102 can be achieved at high levels.

The head cleaning method of the present invention is a head cleaning method in the inkjet recording apparatus, and includes a cleaning process of the head face 500a with the wiping cloth 102 in the above-described inkjet recording apparatus 1. In the head cleaning method, the controller 40 controls the wiping cloth conveyor as described above.

A program according to the present invention is a program that causes a computer in the above-described inkjet recording apparatus 1 to function as the controller 40. The computer functioning as the controller 40 by the program controls the wiping cloth conveyor as described above.

According to the present embodiment, it is possible to provide an inkjet recording apparatus, a head cleaning method, and a recording medium for a program that can reduce consumption of a wiping cloth.

Although embodiments and modification examples of the present invention have been described and illustrated in detail, the disclosed embodiments and modification examples have been created for purposes of illustration and example only, and not limitation. The scope of the present invention should be interpreted by terms of the appended claims.

The entire disclosure of Japanese Patent Application No.2024-082483, filed on May 21, 2024, including description, claims, drawings and abstract is incorporated herein by reference in its entirety.

What is claimed is:

1. An inkjet recording apparatus comprising:
a head module that is one or a plurality of head modules each including an inkjet head that is one or a plurality of inkjet heads;
a wiping cloth for cleaning a head face of the inkjet head;
a contact mechanism that causes the wiping cloth to contact and separate from the head face;
a wiping cloth conveyor that conveys the wiping cloth; and
a hardware processor that controls the wiping cloth conveyor, wherein
when first and second cleaning operations of two consecutive cleaning operations are defined as a first cleaning operation and a second cleaning operation, respectively, an area of the wiping cloth to which ink adheres by the first cleaning operation is defined as a first ink adhesion area, and an area of the wiping cloth to which ink adheres by the second cleaning operation is defined as a second ink adhesion area,
in a case where an ink adhesion amount to the wiping cloth by the first cleaning operation is small, the hardware processor increases an overlapping area of the first ink adhesion area and the second ink adhesion area as compared with a case where the ink adhesion amount is large.

2. The inkjet recording apparatus according to claim 1, wherein
the ink adhesion amount to the wiping cloth by the first cleaning operation is a value estimated based on a cleaning mode of the first cleaning operation.

3. The inkjet recording apparatus according to claim 1, wherein
when an elapsed time from wiping completion in the first cleaning operation to wiping start in the second cleaning operation is defined as a first elapsed time,
the hardware processor further controls the overlapping area in accordance with a length of the first elapsed time.

4. The inkjet recording apparatus according to claim 3, wherein
in a case where the first elapsed time is long, the hardware processor reduces the overlapping area compared to a case where the first elapsed time is short.

5. The inkjet recording apparatus according to claim 3, wherein
in a case where the first elapsed time is one hour or more, the hardware processor sets the overlapping area to zero.

6. The inkjet recording apparatus according to claim 1, wherein
when a degree of drying or thickening of the ink adhered to the wiping cloth by the first cleaning operation in the second cleaning operation is defined as a first denaturation degree,
the hardware processor further controls the overlapping area according to a magnitude of the first denaturation degree.

7. The inkjet recording apparatus according to claim 6, wherein
in a case where the first denaturation degree is large, the hardware processor reduces the overlapping area compared to a case where the first denaturation degree is small.

8. The inkjet recording apparatus according to claim 1,
when the head module cleaned in the second cleaning operation is defined as a second head module, and an elapsed time from wiping completion in a previous cleaning operation of the second cleaning operation for the second head module to wiping start in the second cleaning operation is defined as a second elapsed time, the hardware processor further controls the overlapping area in accordance with a length of the second elapsed time.

9. The inkjet recording apparatus according to claim 8, wherein
in a case where the second elapsed time is long, the hardware processor reduces the overlapping area compared to a case where the second elapsed time is short.

10. The inkjet recording apparatus according to claim 8, wherein
the hardware processor sets the overlapping area to zero when the second elapsed time is one hour or longer.

11. The inkjet recording apparatus according to claim 1, wherein
when the head module cleaned in the second cleaning operation is defined as a second head module, and a degree of drying or thickening of the ink adhering to the second head module in the second cleaning operation is defined as a second denaturation degree,
the hardware processor further controls the overlapping area according to a magnitude of the second denaturation degree.

12. The inkjet recording apparatus according to claim 11, wherein
in a case where the second denaturation degree is large, the hardware processor reduces the overlapping area compared to a case where the second denaturation degree is small.

13. The inkjet recording apparatus according to claim 1, wherein
the head face includes a nozzle face having a nozzle opening and a top plate surrounding the nozzle face.

14. The inkjet recording apparatus according to claim 13, wherein
when an area of the wiping cloth with which the nozzle face is in contact in the first cleaning operation is defined as a first nozzle face contact area, and an area of the wiping cloth with which the nozzle face is in contact in the second cleaning operation is defined as a second nozzle face contact area,
the hardware processor controls the wiping cloth conveyor such that the first nozzle face contact area and the second nozzle face contact area do not overlap each other.

15. The inkjet recording apparatus according to claim 13, wherein
when an area of the wiping cloth with which the top plate comes into contact in the first cleaning operation is defined as a first top plate contact area, and an area of the wiping cloth with which the nozzle face comes into contact in the second cleaning operation is defined as a second nozzle face contact area,
the hardware processor controls the wiping cloth conveyor such that the first top plate contact area and the second nozzle face contact area do not overlap each other.

16. The inkjet recording apparatus according to claim 1, further comprising a conveyance amount detector that detects a conveyance amount of the wiping cloth.

17. A head cleaning method in an inkjet recording apparatus that includes: a head module that is one or a plurality of head modules each including an inkjet head that is one or a plurality of inkjet heads; a wiping cloth for cleaning a head face of the inkjet head; a contact mechanism that causes the wiping cloth to contact and separate from the head face; a wiping cloth conveyor that conveys the wiping cloth; and a hardware processor that controls the wiping cloth conveyor, the method comprising cleaning of the head face with the wiping cloth, wherein
when first and second cleaning operations of two consecutive cleaning operations are defined as a first cleaning operation and a second cleaning operation, respectively, an area of the wiping cloth to which ink adheres by the first cleaning operation is defined as a first ink adhesion area, and an area of the wiping cloth to which ink adheres by the second cleaning operation is defined as a second ink adhesion area,
in a case where an ink adhesion amount to the wiping cloth by the first cleaning operation is small, the hardware processor increases an overlapping area of the first ink adhesion area and the second ink adhesion area as compared with a case where the ink adhesion amount is large.

18. A non-transitory computer-readable recording medium storing a program for a computer in an inkjet recording apparatus that includes: a head module that is one or a plurality of head modules each including an inkjet head that is one or a plurality of inkjet heads; a wiping cloth for cleaning a head face of the inkjet head; a contact mechanism that causes the wiping cloth to contact and separate from the head face; a wiping cloth conveyor that conveys the wiping cloth; and the computer, the program causing the computer to function as a hardware processor, wherein
when first and second cleaning operations of two consecutive cleaning operations are defined as a first cleaning operation and a second cleaning operation, respectively, an area of the wiping cloth to which ink adheres by the first cleaning operation is defined as a first ink adhesion area, and an area of the wiping cloth to which ink adheres by the second cleaning operation is defined as a second ink adhesion area,
in a case where an ink adhesion amount to the wiping cloth by the first cleaning operation is small, the hardware processor increases an overlapping area of the first ink adhesion area and the second ink adhesion area as compared with a case where the ink adhesion amount is large.
